(19) United States
(12) Patent Application Publication
(10) Pub. No.: US 2022/0028585 A1
(43) Pub. Date: Jan. 27, 2022

(54) WIRING MEMBER

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Daichi FUKUSHIMA, Mie (JP); Housei MIZUNO, Mie (JP); Miyu ARAMAKI, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/312,078

(22) PCT Filed: Dec. 13, 2018
(86) PCT No.: PCT/JP2018/045872

§ 371 Date: Jun. 9, 2021

(51) Int. Cl. H01B 19/00; H01B 17/56

(52) U.S. Cl. CPC H01B 19/00; H01B 17/56

(57) ABSTRACT

A wiring member includes: a wire-like transmission member including a transmission wire body and a covering for covering the transmission wire body; and a sheet member having a main surface on which the wire-like transmission member is disposed and fixed to the covering by direct fixation to hold the wire-like transmission member. In a portion where the sheet member and the covering are fixed to each other by direct fixation, the sheet member is bended along a periphery of the covering wholly in a thickness direction to wrap the wire-like transmission member.

### TECHNICAL FIELD

The present invention relates to a wiring member.

### BACKGROUND ART

Patent Document 1 discloses a technique of fixing a portion extending straight in a covering wire and a reinforcement material to a band-like body made of soft synthetic resin by heating-pressurizing welding to manufacture a wire harness.

### PRIOR ART DOCUMENTS

### Patent Documents

Patent Document 1: Japanese Utility Model Application Laid-Open No. 58-192408

### SUMMARY

### Problem to be Solved by the Invention

However, in Patent Document 1, there is a possibility that a covering of the covering wire is deformed when the hand-like body and the covering wire are welded.

Accordingly, an object of the present invention is to provide a technique capable of preventing a deformation of a covering of a wire-like transmission member as much as possible in a wiring member in which a sheet member and the covering are fixed to each other by direct fixation.

### Means to Solve the Problem

In order to solve the above problem, a wiring member according to a first aspect includes: a wire-like transmission member including a transmission wire body and a covering for covering the transmission wire body; and a sheet member having a main surface on which the wire-like transmission member is disposed and fixed to the covering by direct fixation to hold the wire-like transmission member, wherein in a portion where the sheet member and the covering are fixed to each other by direct fixation, the sheet member is bended along a periphery of the covering wholly in a thickness direction to wrap the wire-like transmission member.

A wiring member according to a second aspect is the wiring member according to the first aspect, wherein the sheet member includes a first layer fixed to the covering by direct fixation and a second layer overlapping with the first layer, and in the portion where the sheet member and the covering arc fixed to each other by direct fixation, the first layer and the second layer are bended along the periphery of the covering.

A wiring member according to a third aspect is the wiring member according to the first or second aspect, wherein in the portion where the sheet member and the covering are fixed to each other by direct fixation, a portion where the sheet member and the covering have contact with each other along a circumferential direction of the covering is wholly fixed by direct fixation.

A wiring member according to a fourth aspect is the wiring member according to any one of the first to third aspects, wherein in the portion where the sheet member and the covering are fixed to each other by direct fixation, a range of the sheet member wrapping the covering is equal to or larger than a quarter and equal to or smaller than a half of a perimeter of the covering.

### Effects of the Invention

According to each aspect, the sheet member is bended along the periphery of the covering wholly in the thickness direction to wrap the wire-like transmission member. That is to say, the sheet member and the wire-like transmission member are fixed to each other by direct fixation in the state where the sheet member mainly follows the outer periphery of the wire-like transmission member, thus a deformation of the covering can be prevented as much as possible in the wiring member in which the sheet member and the covering of the wire-like transmission member are fixed to each other by direct fixation.

According to the second aspect, also in a ease where the sheet member is made up of two or more layers, the sheet member and the wire-like transmission member are fixed to each other by direct fixation in the state where the sheet member mainly follows the outer periphery of the wire-like transmission member, thus a deformation of the covering can be prevented as much as possible in the wiring member in which the sheet member and the covering of the wire-like transmission member are fixed to each other by direct fixation.

According to the third aspect, fixing strength of the sheet member and the covering by direct fixation can be increased.

Generally, formation achieved more easily as a range of the sheet member wrapping the covering decreases in the portion where the sheet member and the covering are fixed by direct fixation, and the fixing strength gets larger as the range increases. According to the fourth aspect, the range of the sheet member wrapping the covering in the portion where the sheet member and the covering are fixed to each other by direct fixation is equal to or larger than a quarter and equal to or smaller than a half of the perimeter of the covering, thus both formation easiness and ensuring of necessary fixing strength can be easily achieved.

### BRIEF DESCRIPTION OF DRAWINGS

FIG. 1 A plan view illustrating a wiring member according to an embodiment.

FIG. 2 A lateral cross-sectional view of the wiring member cut along a II-II line in FIG. 1.

FIG. 3 An explanation drawing illustrating a manufacture of the wiring member according to the embodiment.

FIG. 4 A drawing for explaining a manufacture of the wiring member according to the embodiment.

### DESCRIPTION OF EMBODIMENT(S)

### Embodiment

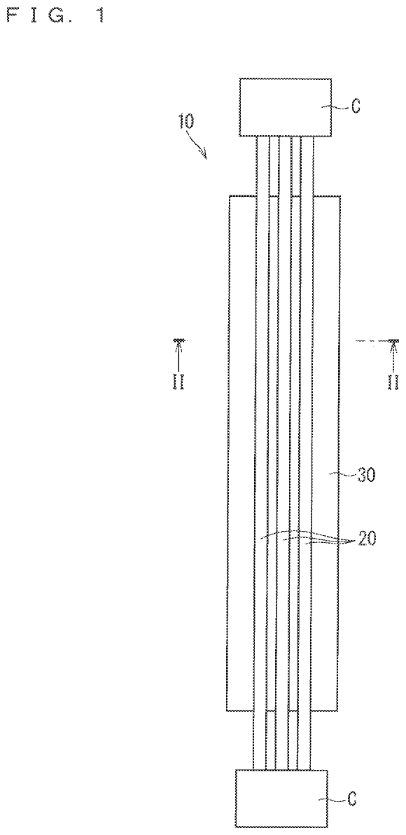

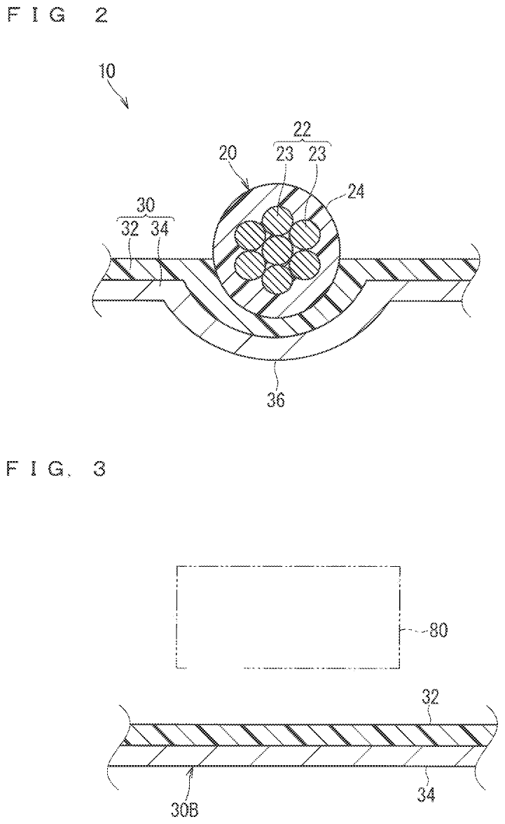

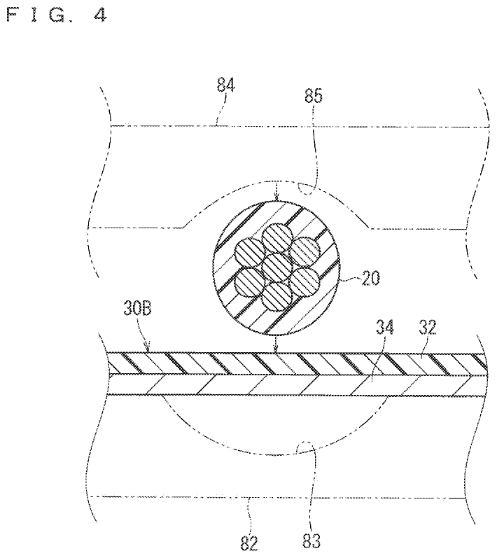

A wiring member according to an embodiment is described hereinafter. FIG. 1 is a plan view illustrating a wiring member 10 according to the embodiment. FIG. 2 is a lateral cross-sectional view of the wiring member cut along a II-II line in FIG. 1. FIG. 3 and FIG. 4 are explanation drawings each illustrating a manufacture of the wiring member 10 according to the embodiment.

The wiring member 10 is a member disposed in a vehicle, for example, to supply electrical power to an apparatus mounted to the vehicle or transmit and receive a signal between apparatuses mounted to the vehicle. The wiring member 10 includes a wire-like transmission member 20 and a sheet member 30.

It is sufficient that the wire-like transmission member 20 is a wire-like member transmitting electrical power or light, for example. The wire-like transmission member 20 includes a transmission wire body 22 transmitting electrical power or light and a covering 24 covering the transmission wire body 22. For example, the wire-like transmission member 20 may be a general wire having a core wire and a covering around the core wire, or may also be a shielded wire, a twisted wire, an enamel wire, a nichrome wire, or an optical fiber. In the example illustrated in FIG. 2, the wire-like transmission member 20 is a general wire, and a core wire 22 made up of a plurality of twisted strands 23 is adopted as the transmission wire body 22. It is obvious that the core wire is made up of one strand.

The wire-like transmission member 20 transmitting the electrical power may be various kinds of signal lines or various kinds of power lines. The wire-like transmission member 20 transmitting the electrical power may be used as an antenna or coil, for example, transmitting or receiving a signal or electrical power to or from a space.

The wire-like transmission member 20 may be a single wire-like object or a composite object of a plurality of wire-like objects (a twisted wire and a cable made up of a plurality of wire-like objects covered by a sheath).

A terminal and a connector C, for example, are appropriately provided in accordance with a connection state of the wire-like transmission member 20 and the other side member in an end portion of the wire-like transmission member 20.

The wire-like transmission member 20 is disposed on one main surface of the sheet member 30. The sheet material 30 keeps the plurality of wire-like transmission members 20 in a state of being arranged side by side. The sheet material 30 is formed into a band-like shape extending along a route of the wire-like transmission member 20. In the example illustrated in. FIG. 1, the sheet member 30 is formed to extend straight.

In the example illustrated in FIG. 1, the wire-like transmission member 30 is disposed straight on the sheet member 30, however, the route of the wire-like transmission member 20 may be appropriately set, thus may also be bended and disposed on the sheet member 30. In this case, the sheet member 30 may also be formed into a bended shape.

In the example illustrated in FIG. 1, the plurality of wire-like transmission members 20 are disposed to extend in parallel to each other, however, routes of the plurality of wire-like transmission members 20 may be appropriately set, thus may also be branched on the sheet member 30 or disposed to intersect with each other along different routes. In this case, the sheet member 30 may also be branched or intersect.

In the example illustrated in FIG. 1, the plurality of the same wire-like transmission members 20 are disposed on one sheet member 30, however, a diameter, a purpose of usage, and a structure of each of the plurality of wire-like transmission members 20 may be appropriately set, thus the wire-like transmission members 20 each having a different diameter, a purpose of usage, and a structure, for example, may be disposed on the same sheet member 30.

The wire-like transmission member 20 and the sheet material 30 are fixed to each other by direct fixation. The wire-like transmission member 20 and the sheet material 30 may be fixed to each other in series along a longitudinal direction by direct fixation, or may also be fixed to each other intermittently by direct fixation. Herein, the direct fixation indicates that resin included in at least one of the wire-like transmission member 20 and the sheet member 30 is melted, thus a contact portion is directly stuck and fixed.

In forming the state of such a direct fixation, the resin is considered to be melted by heat or a solvent, for example. That is to say, the state of the direct fixation may be the state of the direct fixation by the heat or the state of the direct fixation by the solvent. The direct fixation by the heat is preferable.

At this time, a means of forming the state of the direct fixation is not particularly limited, but various means including a known means such as welding, fusion, and melting joint can be used. For example, when the state of the direct fixation by the heat is formed by welding, various welding means such as ultrasonic welding, heating-pressurizing welding, hot air welding, and high frequency welding can be adopted. When the state of the direct fixation is formed by these means, the wire-like transmission member 20 and the sheet material 30 are in the state of the direct fixation by these means. Specifically, when the state of the direct fixation is formed by the ultrasonic welding, for example, the wire-like transmission member 20 and the sheet material 30 are in the state of the direct fixation by the ultrasonic welding. A portion where the state of the direct fixation by the heat is formed by the welding (a fixing portion between the wire-like transmission member 20 and the sheet member 30) may be referred to as a welding part, and herein, the fixing portion by the ultrasonic welding may be referred to as an ultrasonic welding part, and the fixing portion by the heating-pressurizing welding may be referred to as a heating-pressurizing welding part, for example.

In the case of the direct fixation, only the resin included in the covering 24 of the wire-like transmission member 20 may be melted, or only the resin included in the sheet member 30 may be melted. In the case of the direct fixation, both the resin included in the covering 24 of the wire-like transmission member 20 and the resin included in the sheet member 30 may be melted.

The sheet member 30 may be the sheet member 30 having rigidity with a degree of being able to be curved and hold the plurality of wire-like transmission members 20 in a state of being two-dimensionally positioned, or may be the sheet member 30 having rigidity with a degree of being able to keep itself in a flat state and hold the plurality of wire-like transmission members 20 in a state of being two-dimensionally positioned. The sheet member 30 may have a three-dimensional shaped part such as a part made up of a wall partially standing on the sheet member 30.

A material constituting the sheet member 30 is not particularly limited, however, the sheet member 30 is formed of a material containing resin of polyvinyl chloride (PVC), polyethylene terephthalate (PET), or polypropylene (PP), for example. The sheet member 30 may be a sheet material with an inner portion evenly filled or a non-woven sheet, a woven cloth, or a knitted cloth, for example. The sheet member 30 may contain a material such as metal.

The sheet member 30 may be made up of a single layer or a plurality of stacked layers. When the sheet member 30 is made up of the plurality of stacked layers, it is considered that a resin layer and a resin layer are stacked, for example. It is also considered that a resin layer and a metal layer are stacked, for example. Herein, the sheet member 30 includes a first layer 32 and a second layer 34 overlapping with the first layer 32. The first layer 32 is exposed as one main surface of the sheet member 30. The wire-like transmission member 20 is disposed on the first layer 32. The first layer 32 is fixed to the covering 24 by direct fixation.

For example, the first layer 32 is formed by a material fixed to the covering 24 by direct fixation more easily than the second layer 34, and the second layer 34 is formed by a material having a function different from the first layer 32 or high function in a viewpoint of protection performance and soundproof performance. Adoptable as such a sheet member 30 is the sheet member 30 in which the first layer 32 is formed in a state where an inner portion thereof is evenly filled with the same resin material as that of the covering 24 of the wire-like transmission member 20 and the second layer 34 is formed into a non-woven sheet-like shape with a resin material different from that of the covering 24 of the wire-like transmission member 20.

In a portion where the sheet member 30 and the covering 24 are fixed to each other by direct fixation, the sheet member 30 is bended along a periphery of the covering 24 wholly in a thickness direction to wrap the wire-like transmission member 20. Herein, in a portion where the sheet member 30 and the covering 24 are fixed to each other by direct fixation, the first layer 32 and the second layer 34 are bended along a periphery of the covering 24.

A range of the sheet member 30 wrapping the covering 24 in the portion where the sheet member 30 and the covering 24 are fixed to each other by direct fixation is not particularly limited. In the example illustrated in FIG. 2, the range of the sheet member 30 wrapping the covering 24 is substantially a half of a perimeter the covering 24. For example, it is sufficient that the range of the sheet member 30 wrapping the covering 24 takes a value within a range equal to or larger than a quarter and equal to or smaller than a half of the perimeter of the covering 24.

In the portion where the sheet member 30 and the covering 24 are fixed to each other by direct fixation, the portion where the sheet member 30 and the covering 24 have contact with each other along a circumferential direction of the covering 24 is wholly fixed by direct fixation. In the portion where the sheet member 30 and the covering 24 are fixed to each other by direct fixation, only part of the portion where the sheet member 30 and the covering 24 have contact with each other along a circumferential direction of the covering 24 may also be fixed by direct fixation. In this case, it is sufficient that a portion including both end portions in the circumferential direction of the covering 24 in the portion where the sheet member 30 and covering 24 have contact with each other along the circumferential direction is fixed by direct fixation.

The sheet member 30 is bended along the periphery of the covering 24 wholly in the thickness direction to wrap the wire-like transmission member 20, thus a portion of the other main surface of the sheet member 30 corresponding to a rear side of a portion where the wire-like transmission member 20 is fixed by direct fixation constitutes a convex part 36 in which a portion where part in a width direction is convexed extends along a longitudinal direction of the wire-like transmission member 20. In the example illustrated in FIG. 2, an outer surface of the convex part 36 is also formed to have a curved surface, but may also be formed to have a flexed surface, for example.

In the example illustrated in FIG. 3, the sheet member 30 in a state before being fixed to the wire-like transmission member 20 by direct fixation is illustrated. The sheet member 30 in the state before being fixed to the wire-like transmission member 20 by direct fixation is also referred to as the sheet member 30B in some cases hereinafter to be distinguished from the sheet member 30 in a state after being fixed to the wire-like transmission member 20 by direct fixation.

The sheet member 30B is uniformly formed into a flat shape, for example. In this ease, the sheet member 30B preferably has flexibility of easily bending in a front-back direction. Accordingly, when the sheet member 30B is fixed to the wire-like transmission member 20 by direct fixation, the sheet member 30B can be bended along the periphery of the wire-like transmission member 20.

Such a wiring member 10 can be manufactured as follows, for example.

That is to say, at least one of the sheet member 309 and the covering 24 is heated to a temperature at which the direct fixation can be performed, that is a temperature at which the resin is melted (softened). In the example illustrated in FIG. 3, the sheet member 30B is heated by a heating part 80. It is sufficient that the heating part 80 generates hot air, thereby being able to locally heat a portion of the sheet member 30B including a region where the wire-like transmission member 20 is disposed, for example. It is obvious that the heating part 80 may uniformly heat the sheet member 30B.

The region in the sheet member 30B where the wire-like transmission member 20 is disposed is heated and subsequently, portions of the sheet member 30B and the wire-like transmission member 20 fixed to each other by direct fixation are brought into contact with each other. At this lime, they have contact with each other in a state where the sheet member 30B is bended along an outer peripheral surface of the wire-like transmission member 20. For example, as with an example illustrated in FIG. 4, the sheet member 30B and the wire-like transmission member 20 are pressed by molds 82 and 84, thus they have contact with each other in a state where the sheet member 30B is bended along the outer peripheral surface of the wire-like transmission member 20.

More specifically, a groove 83 larger than the wire-like transmission member 20 is formed in the mold 82 on a side of the sheet member 30B. Then, the sheet member 30B and the wire-like transmission member 20 are pressed by the molds 82 and 84 from both sides in a state where the portions of the sheet member 30B and the wire-like transmission member 20 fixed to each other by direct fixation are located on an upper side of the groove 83. Accordingly, the sheet member 30B is housed in the groove 83 and bended into a shape corresponding to the outer peripheral surface of the wire-like transmission member 20, and they have contact with each other.

An outer surface shape of the convex part 36 after the direct fixation can be determined in accordance with a shape of an inner peripheral surface of the groove 83. In the example illustrated in FIG. 4, the inner peripheral surface of the groove 83 is formed to have a curved surface. Thus, the outer surface of the convex part 36 of the sheet member 30 after the direct fixation also has a curved surface.

A contact range of the sheet member 30 and the wire-like transmission member 20 in the circumferential direction can be determined in accordance with a perimeter (depth dimension) of the groove 83. That is to say, when the perimeter (depth dimension) of the groove 83 is small, the contact range of the sheet member 30 and the wire-like transmission member 20 in the circumferential direction decreases, and when the perimeter (depth dimension) of the groove 83 is large, the contact range of the sheet member 30 and the wire-like transmission member 20 in the circumferential direction increases. Herein, the perimeter (depth dimension) of the groove 83 is set so that the contact range of the sheet member 30 and the wire-like transmission member 20 in the circumferential direction is as large as a half periphery of the wire-like transmission member 20.

A groove 85 is formed also in the mold 84 on a side of the wire-like transmission member 20. The groove 85 is formed to be equal to or larger than the wire-like transmission member 20. When the wire-like transmission member 20 is pressed by the mold 84, the wire-like transmission member 20 is housed in the groove 85, thus a movement of the wire-like transmission member 20 in a width direction of the sheet member 30 can be regulated.

The sheet member 30B and the wire-like transmission member 20 have contact with each other in a state where the heated sheet member 30B is bended along the outer peripheral surface of the wire-like transmission member 20, thus the melted resin of at least the sheet member 30B adheres to the covering 24. The resin of the covering 24 may also be melted. The resin adhering to the other side member is hardened, thereby being kept in a state of adhering to the other side member. As a result, the sheet member 30 and the covering 24 are fixed to each other by direct fixation, and in the portion where the sheet member 30 and the covering 24 are fixed to each other by direct fixation, the sheet member 30 is bended along the periphery of the covering 24 wholly in the thickness direction to wrap the wire-like transmission member 20.

Even in the case where the sheet member 30B having the uniform thickness as illustrated in FIG. 3 is fixed to the wire-like transmission member 20 by direct fixation, it is considered that the thickness dimension of the sheet member 30 remains the same along the circumferential direction of the wire-like transmission member 20 in the portion where the sheet member 30 wraps the wire-like transmission member 20 or is not the same. For example, when power of pressing by the molds 82 and 84 is large, the wire-like transmission member 20 is considered to be embedded in the sheet member 30 in a direction of being pressed by the molds 82 and 84 in the sheet member 30. From the other viewpoint, part of the resin in the portion of the sheet member 30 having contact with the wire-like transmission member 20 in the direction of being pressed by the molds 82 and 84 is considered to move toward a lateral side of the wire-like transmission member 20. In this case, a thickness of a portion of the sheet member 30 immediately below the wire-like transmission member 20 is smaller than a thickness of a portion of a lateral side of the wire-like transmission member 20.

According to the wiring member 10 having the above configuration, the sheet member 30 is beaded along the periphery of the covering 24 wholly in the thickness direction to wrap the wire-like transmission member 20. That is to say, the sheet member 30 and the wire-like transmission member 20 are fixed to each other by direct fixation in the state where the sheet member 30 mainly follows the outer periphery of the wire-like transmission member 20, thus a deformation of the covering 24 can be prevented as much as possible in the wiring member 10 in which the sheet member 30 and the covering 24 of the wire-like transmission member 20 are fixed to each other by direct fixation.

Also in a case where the sheet member 30 is made up of two or more layers, the sheet member 30 and the wire-like transmission member 20 are fixed to each other by direct fixation in the state where the sheet member 30 mainly follows the outer periphery of the wire-like transmission member 20, thus a deformation of the covering 24 can be prevented as much as possible in the wiring member 10 in which the sheet member 30 and the covering 24 of the wire-like transmission member 20 are fixed to each other by direct fixation.

In the portion where the sheet member 30 and the covering 24 are fixed to each other by direct fixation, the portion where the sheet member 30 and the covering 24 have contact with each other along the circumferential direction of the covering 24 is wholly fixed by direct fixation, thus fixing strength of the sheet member 30 and the covering 24 by direct fixation can be increased.

Generally, the formation is achieved more easily as the range of the sheet member 30 wrapping the covering 24 decreases in the portion where the sheet member 30 and the covering 24 are fixed by direct fixation, and the fixing strength gets larger as the range increases. The range of the sheet member 30 wrapping the covering 24 in the portion where the sheet member 30 and the covering 24 are fixed to each other by direct fixation is equal to or larger than a quarter and equal to or smaller than a half of the perimeter of the covering 24, thus both formation easiness and ensuring of necessary fixing strength can be easily achieved.

### Modification Example

In the embodiment, the sheet member 30 and the wire-like transmission member 20 are pressed by the molds 82 and 84 after heating in the direct fixation of the sheet member 30 and the wire-like transmission member 20, however, this configuration is not necessary. The heating and pressing (press operation) by the mold may be performed at the same time in the direct fixation of the sheet member 30 and the wire-like transmission member 20. In this case, it is sufficient that the portion where the sheet member 30 and the wire-like transmission member 20 have contact with each other are directly heated as with ultrasonic welding.

Each configuration described in the embodiment and each modification example can be appropriately combined as long as they are not contradictory.

Although the present invention is described in detail, the foregoing description is in all aspects illustrative and does not restrict the invention. It is therefore understood that numerous modifications and variations can be devised without departing from the scope of the invention.

### EXPLANATION OF REFERENCE SIGNS

10 wiring ember

20 wire-like transmission member

22 transmission wire body

24 covering

30 sheet member

32 first layer

34 second layer

36 convex part

1. A wiring member, comprising:
at least one wire-like transmission member including a transmission wire body and a covering for covering the transmission wire body; and
a sheet member having a main surface on which the wire-like transmission member is disposed and fixed to the covering by direct fixation to hold the wire-like transmission member, wherein
the plurality of wire-like transmission members are arranged in parallel to each other on the sheet member,
some of the plurality of wire-like transmission members arranged in parallel to each other on the sheet member are disposed separately in a parallel direction,
in a portion where the sheet member and the covering are fixed to each other by direct fixation, the sheet member is bended along a periphery of the covering wholly in a thickness direction to wrap the wire-like transmission member, and
a thickness of a portion of the sheet member immediately below the wire-like transmission member is smaller than a thickness of a portion of a lateral side of the wire-like transmission member.

2. The wiring member according to claim 1, wherein
the sheet member includes a first layer fixed to the covering by direct fixation and a second layer overlapping with the first layer, and
in the portion where the sheet member and the covering are fixed to each other by direct fixation, the first layer and the second layer are bended along the periphery of the covering.

3. The wiring member according to claim 1, wherein
in the portion where the sheet member and the covering are fixed to each other by direct fixation, a portion where the sheet member and the covering have contact with each other along a circumferential direction of the covering is wholly fixed by direct fixation.

4. The wiring member according to claim 1, wherein
in the portion where the sheet member and the covering are fixed to each other by direct fixation, a range of the sheet member wrapping the covering is equal to or larger than a quarter and equal to or smaller than a half of a perimeter of the covering.
